(19) United States
(12) Patent Application Publication
(10) Pub. No.: US 2014/0273884 A1
(43) Pub. Date: Sep. 18, 2014

(54) WLAN DIVERSITY/MIMO USING SHARED ANTENNA

(71) Applicant: QUALCOMM INCORPORATED, San Diego, CA (US)

(72) Inventors: Ashok Mantravadi, San Diego, CA (US); Tamer Adel Kadous, San Diego, CA (US)

(73) Assignee: QUALCOMM INCORPORATED, San Diego, CA (US)

(21) Appl. No.: 13/801,881

(22) Filed: Mar. 13, 2013

(51) Int. Cl. H04B 1/38

(52) U.S. Cl. CPC H04B 1/38
USPC 455/73

(57) ABSTRACT

A UE with a limited number of antennas may support multiple radio access technologies (RATS). In some instances, the UE may configure a shared antenna for use by a wireless local area network (WLAN) radio access technology (RAT) or a cellular RAT. The UE may also allocate the shared antenna to the WLAN RAT when the cellular RAT is active based at least in part on an operating condition of the WLAN RAT and/or the cellular RAT.

### TECHNICAL FIELD

Aspects of the present disclosure relate generally to communication systems, and specifically to wireless local area network (WLAN) diversity/multiple-input multiple-output (MIMO) technology using a shared antenna.

### BACKGROUND OF RELATED ART

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes configuring a shared antenna for use by a wireless local area network (WLAN) radio access technology (RAT) or a cellular RAT. The method may also include allocating the shared antenna to the WLAN RAT when the cellular RAT is active based at least in part on an operating condition of the WLAN RAT and/or the cellular RAT.

According to one aspect of the present disclosure, a method for wireless communication includes configuring a shared antenna for use by a wireless local area network (WLAN) radio access technology (RAT) or a cellular RAT. The method may also include comparing a strength of the shared antenna to a dedicated WLAN antenna of a UE having a single receive chain. The method may further include allocating the shared antenna or the dedicated WLAN antenna for WLAN communication based at least in part on the comparison.

According to another aspect of the present disclosure, an apparatus for wireless communication includes means for configuring a shared antenna for use by a wireless local area network (WLAN) radio access technology (RAT) or a cellular RAT. The apparatus may also include means for allocating the shared antenna to the WLAN RAT when the cellular RAT is active based at least in part on an operating condition of the WLAN RAT and/or the cellular RAT.

According to another aspect of the present disclosure, an apparatus for wireless communication includes means for configuring a shared antenna for use by a wireless local area network (WLAN) radio access technology (RAT) or a cellular RAT. The apparatus may also include means for comparing a strength of the shared antenna to a dedicated WLAN antenna of a UE having a single receive chain. The apparatus may further include means for allocating the shared antenna or the dedicated WLAN antenna for WLAN communication based at least in part on a comparison by the comparing means.

According to one aspect of the present disclosure, a computer program product for wireless communication in a wireless network includes a computer readable medium having non-transitory program code recorded thereon. The program code includes program code to configure a shared antenna for use by a wireless local area network (WLAN) radio access technology (RAT) or a cellular RAT. The program code also includes program code to allocate the shared antenna to the WLAN RAT when the cellular RAT is active based at least in part on an operating condition of the WLAN RAT and/or the cellular RAT.

According to one aspect of the present disclosure, a computer program product for wireless communication in a wireless network includes a computer readable medium having non-transitory program code recorded thereon. The program code includes program code to configure a shared antenna for use by a wireless local area network (WLAN) radio access technology (RAT) or a cellular RAT. The program code also includes program code to compare a strength of the shared antenna to a dedicated WLAN antenna of a UE having a single receive chain. The program code further includes program code to allocate the shared antenna or the dedicated WLAN antenna for WLAN communication based at least in part on the comparison.

According to one aspect of the present disclosure, an apparatus for wireless communication includes a memory and a processor(s) coupled to the memory. The processor(s) is configured to configure a shared antenna for use by a wireless local area network (WLAN) radio access technology (RAT) or a cellular RAT. The processor(s) is further configured to allocate the shared antenna to the WLAN RAT when the cellular RAT is active based at least in part on an operating condition of the WLAN RAT and/or the cellular RAT.

According to one aspect of the present disclosure, an apparatus for wireless communication includes a memory and a processor(s) coupled to the memory. The processor(s) is configured to configure a shared antenna for use by a wireless local area network (WLAN) radio access technology (RAT) or a cellular RAT. The processor(s) is further configured to compare a strength of the shared antenna to a dedicated WLAN antenna of a UE having a single receive chain. The processor(s) is further configured to allocate the shared antenna or the dedicated WLAN antenna for WLAN communication based at least in part on a comparison by the processor.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is an example of a multiple access wireless communication system.

FIG. 2 is a block diagram of an aspect of a transmitter system and a receiver system in a MIMO system.

FIG. 3 depicts wireless devices within which the present aspects can be implemented.

FIG. 4 is a high-level block diagram of a wireless device capable of dynamically sharing antennas.

FIG. 5 is a block diagram of one aspect of the wireless device of FIG. 4.

FIG. 6 is a flow chart depicting an exemplary operation of a wireless device dynamically sharing antennas in accordance with some aspects.

FIG. 7 is a flow chart depicting another exemplary operation of a wireless device dynamically sharing antennas in accordance with some aspects.

FIG. 8 is a diagram illustrating an example of a hardware implementation for an apparatus employing a dynamic antenna sharing system.

### DETAILED DESCRIPTION

Aspects of the present disclosure are discussed below in the context of dynamically sharing antennas in a mobile communication device capable of transmitting and receiving wireless local area network (WLAN) signals, and long-term evolution (LTE) signals. It is to be understood, however, that the present aspects are equally applicable for dynamically sharing antennas used for transmitting or receiving signals of other various wireless standards or protocols such as Bluetooth, Global Positioning System, 1x radio transmission technology (1X)), Evolution Data Optimized (EV-DO) or any other cellular technology. In the following description, numerous specific details are set forth such as examples of specific components, circuits, software and processes to provide a thorough understanding of the present disclosure. Also, for purposes of explanation, specific nomenclature is set forth to provide a thorough understanding of the present aspects. However, it will be apparent to one skilled in the art that these specific details may not be required to practice the present aspects. In other instances, well-known circuits and devices are shown in block diagram form to avoid obscuring the present disclosure. The term “coupled” as used herein means connected directly, connected through one or more intervening components or circuits and/or wirelessly connected. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of myriad physical or logical mechanisms for communication between components.

Referring to FIG. 1, a multiple access wireless communication system according to one aspect is illustrated. An evolved Node B 100 (eNB) includes a computer 115 that has processing resources and memory resources to manage the LTE communications by allocating resources and parameters, granting/denying requests from user equipment, and/or the like. The eNB 100 also has multiple antenna groups, one group including antenna 104 and antenna 106, another group including antenna 108 and antenna 110, and an additional group including antenna 112 and antenna 114. In FIG. 1, only two antennas are shown for each antenna group, however, more or fewer antennas can be utilized for each antenna group. A User Equipment (UE) 116 (also referred to as an Access Terminal (AT)) is in communication with antennas 112 and 114, while antennas 112 and 114 transmit information to the UE 116 over an uplink (UL) 188. The UE 122 is in communication with antennas 106 and 108, while antennas 106 and 108 transmit information to the UE 122 over a downlink (DL) 126 and receive information from the UE 122 over an uplink 124. In a frequency division duplex (FDD) system, communication links 118, 120, 124 and 126 can use different frequencies for communication. For example, the downlink 120 can use a different frequency than used by the uplink 118.

Each group of antennas and/or the area in which they are designed to communicate is often referred to as a sector of the eNB. In this aspect, respective antenna groups are designed to communicate to UEs in a sector of the areas covered by the eNB 100.

In communication over the downlinks 120 and 126, the transmitting antennas of the eNB 100 utilize beamforming to improve the signal-to-noise ratio of the uplinks for the different UEs 116 and 122. Also, an eNB using beamforming to transmit to UEs scattered randomly through its coverage causes less interference to UEs in neighboring cells than a UE transmitting through a single antenna to all its UEs.

An eNB can be a fixed station used for communicating with the terminals and can also be referred to as an access point, base station, or some other terminology. A UE can also be called an access terminal, a wireless communication device, terminal, or some other terminology.

FIG. 2 is a block diagram of an aspect of a transmitter system 210 (also known as an eNB) and a receiver system 250 (also known as a UE) in a MIMO system 200. In some instances, both a UE and an eNB each have a transceiver that includes a transmitter system and a receiver system. At the transmitter system 210, traffic data for a number of data streams is provided from a data source 212 to a transmit (TX) data processor 214.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, wherein NS≦min{NT, NR}. Each of the NS independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the uplink and downlink transmissions are on the same frequency region so that the reciprocity principle allows the estimation of the downlink channel from the uplink channel. This enables the eNB to extract transmit beamforming gain on the downlink when multiple antennas are available at the eNB.

In an aspect, each data stream is transmitted over a respective transmit antenna. The TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is a known data pattern processed in a known manner and can be used at the receiver system to estimate the channel response. The multiplexed pilot and coded data for each data stream is then modulated (e.g., symbol mapped) based on a particular modulation scheme (e.g., BPSK, QSPK, M-PSK, or M-QAM) selected for that data stream to provide modulation symbols. The data rate, coding, and modulation for each data stream can be determined by instructions performed by a processor 230 operating with a memory 232.

The modulation symbols for respective data streams are then provided to a TX MIMO processor 220, which can further process the modulation symbols (e.g., for OFDM). The TX MIMO processor 220 then provides NT modulation symbol streams to NT transmitters (TMTR) 222a through 222t. In certain aspects, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from the transmitters 222a through 222t are then transmitted from NT antennas 224a through 224t, respectively.

At a receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NR “detected” symbol streams. The RX data processor 260 then demodulates, deinterleaves, and decodes each detected symbol stream to recover the traffic data for the data stream. The processing by the RX data processor 260 is complementary to the processing performed by the TX MIMO processor 220 and the TX data processor 214 at the transmitter system 210.

A processor 270 (operating with a memory 272) periodically determines which pre-coding matrix to use (discussed below). The processor 270 formulates an uplink message having a matrix index portion and a rank value portion.

The uplink message can include various types of information regarding the communication link and/or the received data stream. The uplink message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by antennas 224, conditioned by receivers 222, demodulated by a demodulator 240, and processed by an RX data processor 242 to extract the uplink message transmitted by the receiver system 250. The processor 230 then determines which pre-coding matrix to use for determining the beamforming weights, then processes the extracted message.

### WLAN Diversity/MIMO Using Shared Antenna

Many wireless devices are capable of wireless communication with other devices using wireless local area network (WLAN) signals, Bluetooth (BT) signals, and/or cellular signals. For example, many laptops, netbook computers, and tablet devices use WLAN signals (also commonly referred to as Wi-Fi signals) to wirelessly connect to networks such as the Internet and/or private networks, and use Bluetooth signals to communicate with local BT-enabled devices such as headsets, printers, scanners, and the like. Wi-Fi communications are governed by the IEEE 802.11 family of standards, and Bluetooth communications are governed by the IEEE 802.15 family of standards. Wi-Fi and Bluetooth signals typically operate in the ISM band (e.g., 2.4-2.48 GHz). Further, modern mobile communication devices (such as tablet devices and cellular phones) are also capable of wireless communication using cellular protocols such as long term evolution (“LTE”) protocols, which typically operate in the range of 2.5 GHz.

Multiple antennas and/or receivers/transmitters may be provided to facilitate multimode communication with various combinations of antenna and receiver/transmitter configurations. Each radio technology may transmit or receive signals via one or more antennas. The number of antennas on a wireless device (e.g., user equipment) may be limited due to space/cost constraints and coupling issues. As a result, it is desirable to support all radio technologies on the wireless device with a limited number of antennas such that desired performance may be achieved.

FIG. 3 shows wireless devices 300 such as a laptop and a cellular phone that can be configured to dynamically share antennas for transmitting and receiving wireless signals using different protocols. In addition to having both Wi-Fi and Bluetooth signaling capabilities, wireless devices 300 may also be capable of communicating wirelessly over cellular data networks, for example, using long term evolution (LTE) and/or other suitable cellular communication protocols. Although not shown, the wireless devices 300 may include other devices such as a tablet computer, a desktop computer, PDAs, and so on. For some aspects, wireless devices 300 may use Wi-Fi signals to exchange data with the Internet, LAN, WLAN, and/or VPN. In addition the wireless devices 300 may use Bluetooth signals to exchange data with local Bluetooth-enabled devices such as headsets, printers, scanners, as well as LTE signals to implement cellular phone communication with other wireless devices.

FIG. 4 is a high-level functional block diagram of the wireless device 300 shown to include core logic 410, transceiver control logic 420, and two or more antennas 430 and 440. The core logic 410, which can include well-known elements such as processors and memory elements, performs general data generation and processing functions for the wireless device 300. The transceiver control logic 420 includes a WLAN control circuit 421, a Bluetooth control circuit 422, and a LTE control circuit 423, and is coupled to core logic 410 and to external antennas 430 and 440. The WLAN control circuit 421 is configured to control the transmission and reception of Wi-Fi signals for device 300. The Bluetooth control circuit 422 is configured to control the transmission and reception of Bluetooth signals for device 300. The LTE control circuit 423 is configured to control the transmission and reception of LTE or other cellular signals for device 300. The various components (not shown for simplicity) within core logic 410, WLAN control circuit 421, Bluetooth control circuit 422, and/or LTE control circuit 423 can be implemented in a variety of ways including, for example, using analog circuitry, digital logic, processors (e.g., CPUs, DSPs, microcontrollers, and so on), application specific integrated circuits (ASICs), field programmable gate arrays (FPGAs), or any combination of the above.

Wireless device 300 further includes antenna sharing logic 450 to selectively couple the WLAN control circuit 421, the Bluetooth control circuit 422, and the LTE control circuit 423 to the antennas 430 and/or 440. For some aspects, when one of the WLAN control circuit 421, the Bluetooth control circuit 422, or the LTE control circuit 423 is not transmitting or receiving data, the antenna sharing logic 450 provisions the antennas 430 and 440 for use by the other two control circuits, for example, so that each of the other two control circuits is effectively coupled to a dedicated antenna (described in greater detail below). Further, although shown in FIG. 4 as separate components, the WLAN control circuit 421, the Bluetooth control circuit 422, and/or the LTE control circuit 423 can be implemented on the same integrated circuit (IC) chip by sharing the components on the chip, for example. For other aspects, the core logic 410, the transceiver control logic 420, and the antenna sharing logic 450 can all be implemented on the same IC chip.

FIG. 5 shows a wireless device or user equipment (UE) 500 that is one aspect of device 300 of FIG. 4. The UE 500 may include a transceiver control logic including WLAN control circuit 421 and LTE control circuit 423. The UE 500 may also include a diplexer and/or switch 530 and a set of antennas 531-533. A switch may be used instead of a diplexer to improve flexibility when the LTE and the WLAN frequency bands are close. Further, using the switch allows for use of a diversity chain for WLAN transmit (MIMO) in conjunction with WLAN receiver. In one aspect of the present disclosure, the diplexer and/or switch 530 may be implemented in conjunction with an antenna sharing logic (e.g., antenna sharing logic 450) to facilitate sharing of the antennas 531-533 between the WLAN control circuit 421, and LTE control circuit 423. The antennas 531-533 are well-known. For example, the antenna 533 may be an LTE primary antenna, the antenna 532 may be a diversity antenna configured to be shared between the WLAN control circuit 421, and LTE control circuit 423, and the antenna 531 may be a WLAN primary antenna. The diversity antenna configured for LTE, for example, may be used for WLAN communication because of the large frequency range (i.e., including the WLAN frequency band) covered by the LTE diversity antenna. In some aspects of the disclosure, some antennas may be resized to accommodate both LTE and WLAN communications. The WLAN control circuit 421 is coupled to the first and second antennas 531 and 532. The LTE control circuit 423 is coupled to the second and third antennas 532 and 533.

The first antenna 531 handles the communication of a first WLAN signal WF1 and the third antenna 533 handles the communication of a first LTE signal LT1. The diplexer and/or switch 530 are coupled to the antenna 532 as well as the WLAN control circuit 421 and the LTE control circuit 423. In this aspect, the diplexer and/or switch 530 includes a first port 534 to communicate (i.e., transmit/receive) a second WLAN or Wi-Fi signal WF2 to/from the WLAN control circuit 421 and a second port 535 to communicate a second LTE signal LT2 to/from the LTE control circuit 423. In addition, the diplexer and/or switch 530 include a third port 536 to communicate WLAN signals or LTE signals (e.g., WF2 or LT2) to/from the antenna 532. The diplexer and/or switch 530 may be configured to operate in either an “LTE antenna sharing” mode or an “LTE pass-thru” mode by switching between WLAN control circuit 421 and the LTE control circuit 423. In the pass-thru mode, the first antenna 531 handles the communication of the WLAN signal represented by the first WLAN signal WF1. The second antenna 532 handles the communication of the second LTE signal LT2. Thus, in the pass-thru mode, the diplexer and/or switch 530 “passes through” the second LTE signal LT2 based on a switching implementation. As a result, the LTE signal LT2 uses the second antenna 532 as a dedicated antenna.

In the antenna sharing mode, the diplexer and/or switch 530 couples the second WLAN signal WF2 to the second antenna 532 thereby effectively routing the WLAN signal WF2 (rather than the LTE signal LT2) to the second antenna 532. In this antenna sharing mode, the first antenna 531 handles the communication of the first WLAN signal WF1, the second antenna 532 handles the communication of the second WLAN signal WF2, and the third antenna 533 handles the communication of the LTE signal represented by LT1. Thus, in the antenna sharing mode, the first WLAN signal WF1 uses first antenna 531 as a dedicated antenna, the second WLAN signal WF2 uses the second antenna 532 as a dedicated antenna, and the first LTE signal LT1 uses third antenna 533 as a dedicated antenna. In this manner, the second antenna 532 (which normally handles LTE signal LT2) is shared with the WLAN signal WF2 to improve WLAN communication throughput. Thus, the WLAN control circuit 421 communicates the first and second WLAN signals WF1 and WF2 that are concurrently communicated by the first and second antennas 531 and 532, respectively (e.g., according to well-known WLAN protocols).

Generally, LTE communications may have priority to shared antennas (e.g., diversity antenna). Having this priority is especially useful when the UE is outdoors where the WLAN communications are turned off instead of indoors where WLAN communications are active. However, the allocation of priority may be adjusted or reversed based on the LTE and/or WLAN communication traffic. For example, cellular communications handled by the LTE control circuit 423, may experience regular periods of idle time (e.g., when not receiving or sending any calls). The periods of idle time may be associated with a discontinuous reception cycle such as during LTE communication gaps and/or when LTE communication is turned off. Rather than let the second antenna 532 sit unused during such idle time, an antenna sharing logic (e.g., antenna sharing logic 450) in conjunction with the diplexer and/or switch 530 selectively couples the WLAN signal WF2 to the second antenna 532 during the LTE idle time. In this manner, the dedicated antenna is effectively provisioned for each of the WLAN signals WF1 and WF2 during LTE idle times. Thus, the UE may be enabled to transmit and/or receive multiple streams of WLAN signals concurrently via separate antennas 531 and 532.

In one aspect of the present disclosure, the WLAN communication may have a higher priority than the LTE communication even when the LTE communication is active. In this case, the shared antenna may be allocated for WLAN communication even when the LTE communication is in an active mode. For example, the shared antenna may be allocated for WLAN communication when the UE is within LTE coverage and the LTE communication is in constant rate traffic such as voice over internet protocol (VOIP) and the WLAN communication is a high data rate communication. In some aspects, the WLAN communication may be prioritized over the LTE communication when the WLAN communication is a limiting link during MiFi communications. For example, during MiFi communications, data received on the LTE downlink is also transmitted by the WLAN on the wireless device. In this case, the antennas may be allocated such that LTE downlink rate is matched to the WLAN transmit rate. If the WLAN transmit rate is less than the LTE downlink rate (i.e., limiting link during MiFi communications), then the LTE antenna may be allocated to WLAN even when LTE is in active mode.

In one aspect of the present disclosure, the switch 530 may be used in conjunction with an antenna manager for the assignment of shared antennas to prioritize the assignment of a shared antenna based at least in part on a signal to noise ratio (SINR) of the LTE communication and/or the data rate of the WLAN communication. In this aspect, the SINR of the LTE communication is compared to a SINR threshold and the data rate of the WLAN communication is compared to a data rate threshold. The shared antenna may be allocated for WLAN communication when the SINR of the LTE communication is above the SINR threshold and when the data rate of the WLAN communication is below the data rate threshold. Alternately, the shared antenna may be allocated for WLAN when the specified data rate of the WLAN communication is above or in some cases below the current WLAN data rate. Otherwise, the shared antenna is allocated for the LTE communication. Although switching from a shared antenna for WLAN communication back to LTE communication may result in loss of packets, the packet loss associated with WLAN communication may be remedied by retransmitting the lost packet.

While in some aspect the LTE control circuit 423 is shown coupled to two antennas 532 and 533, in alternative aspects the LTE control circuit 423 may be coupled to just a single antenna (e.g., the second antenna 532) or more than two antennas. The additional antennas or the single antenna available for LTE or any other cellular/wide area network (WAN) technology may be shared with WLAN technology as discussed herein. For example, the diversity antenna for LTE may be used for WLAN communication or may be dedicated for LTE while the additional antennas are shared between LTE and WLAN.

Although additional antennas may be available for WLAN communications, some UEs may include a single WLAN receive chain. As a result, only one antenna may be supported by the UE for WLAN communication at any given point in time. Some aspects of the disclosure accommodate the lack of additional receive chains for WLAN communication based on a switched antenna diversity implementation. In the switched antenna diversity implementation, whenever an additional antenna is available for WLAN communication, the additional antenna is compared against a dedicated or current antenna allocated for WLAN communication. In one aspect, the additional antenna or the dedicated antenna is selected for WLAN communication based on the comparison. The comparison may be based on the signal strength of the antennas, signal to noise ratio or the performance of the antennas. In this aspect, the antenna with the higher signal strength or better performance may be selected for WLAN communication.

If the WLAN access point has only two antennas and the WLAN wireless device has only two antennas, the maximum number of data streams supported by the access point is two. In this case, the number of data streams supported by the two antenna access point does not increase with an increase in the number of antennas available to the WLAN wireless device. Thus, if the number of antennas allocated to the wireless device is increased to three, for example, the number of data streams supported by the access point is still two. In this case, however, the extra antenna allocated to the wireless device may be used to support or improve receiver diversity rather than to support additional streams of data.

The WLAN systems may include a 2×2 system, for example, including a transmitter with two transmitting antennas and a receiver with two receiving antennas. In other aspects, the WLAN system may include a 1×1 system comprising a transmitter with one transmitting antenna and a receiver with one receiving antenna. Communication throughput in the 1×1 system may be improved by an antenna selection followed a 1×1 WLAN operation or by using two receive chains to operate in full diversity mode. In still further aspects, the LTE control circuit 423 may include or be replaced with a control circuit for any type of cellular communications protocol (e.g., EDGE, UMTS, WiMax, EV-DO, etc.). In addition, the WLAN network may be a Wi-Fi network, GPS or the like.

Whether data rate for communication with the UE is adapted depends on the UE's corresponding access point's knowledge of the UE's antenna capability during communication. For example, during WLAN communication the UE communicates with an access point associated with WLAN technology using one antenna and two antennas according to some aspects of the present disclosure. While, the access point may know which UEs have two or more antenna capability, the access point may not know when an additional antenna associated with LTE, for example, is shared with WLAN.

Conventionally, one or more UE antenna capability indications may be sent to an access point at the start of a communication session. Further indications of UE capability are not used, as UE antenna capability did not conventionally change during a duration of a communication connection. In this case, the access point may not know when one or more additional antennas are allocated for WLAN communication. As a result, the communication rate allocated by the access point to the UE is unaffected by an increase in the number of antennas allocated to the UE. For example, the UE may apply an implicit implementation where the WLAN communication rate remains the same despite the increase in the number of antennas allocated to WLAN or where the WLAN communication rate is expected to change over time as the additional antenna(s) increase the rate at which WLAN packets are decoded at the UE. The delay associated with the change of WLAN communication rate in the implicit implementation can be upwards of tens of milliseconds or hundreds of milliseconds. Aspects of the present disclosure include an explicit implementation to reduce the delay in rate adaptation when additional antennas are allocated for WLAN communication.

The UE antenna capability may change during the communication connection. As a result, antennas may be shared by different RATs dynamically during UE operation, resulting in switching of antennas between the different RATs. For example, at the start of a connection, a user equipment may only have two antenna capability on a particular RAT (for example, LTE) and one antenna capability on a different RAT (e.g., WLAN). Accordingly, the UE may indicate to the access point associated with WLAN at the start of the connection that the UE has a single antenna capability for WLAN communication. During the communication connection, however, one or more additional antennas may become available to the UE for WLAN communications. For example, the diversity antenna allocated for LTE can be shared for WLAN communication. At this point, the antenna capability of the UE is changed to two or more antennas for WLAN communication. Presently, the access point would have no way of recognizing this change in the UE capability. Aspects of the present disclosure provide an update of the UE antenna capability when an antenna becomes available or unavailable to the UE for a particular RAT after the start of the communication connection.

One aspect of the present disclosure includes an explicit implementation to reduce the delay in rate adaptation when additional antennas are allocated for WLAN communication. In this aspect, the UE antenna capability may be updated during or after the start of the communication connection. Updating the UE antenna capability includes dynamically sending an indication to the access point, whenever the antenna capability of the UE changes after the start of the communication connection. In one aspect of the disclosure, the UE may dynamically indicate that it supports a single antenna or multiple antennas for WLAN communication during or after the start of the communication connection. Thus, the UEs indication of its antenna capability is dynamic and/or is subject to change throughout the duration of the communication connection.

In one aspect of the disclosure, the UE antenna capability may be updated by modifying channel state information (CSI) of the UE. The CSI may be sent to the access point in response to sounding packets from the access point. When additional antennas become available for WLAN communication, the UE may modify the CSI to improve the overall scheduling capacity. Other communication information beyond CSI may be used. For example, a management frame, an operating mode notification frame or a reassociation request frame may indicate among others, whether the UE is capable of an increased throughput mode and the number of streams that the UE can support. The management frame may be sent from the UE to the access point during association or re-association of the UE with the access point. When the UE discovers a first access point for a first time, an association/authentication procedure is implemented to associate the UE with the first access point. Similarly, when the UE is out of coverage (e.g., temporarily) of the first access point, the association between the UE and the first access point is lost or the UE de-associates with the first access point. In this case, the UE may associate with a second stronger access point. After the de-association from the first access point, the UE may re-associate with the first access point when the first access point becomes stronger. In this case, the management frame is used to inform the access point of the change in the antenna capability when the antenna capability changes before the association or re-association. In other aspects, an operating mode notification frame or a reassociation request frame may be sent without de-associating from the access point.

FIG. 6 is a flow chart depicting an exemplary operation of a wireless device dynamically sharing antennas in accordance with some aspects. As shown in FIG. 6, a device in a wireless system, that may be at least a UE, eNodeB, or an access point, may configure a shared antenna for use by a wireless local area network (WLAN) radio access technology (RAT) or a cellular RAT as shown in block 602, and may allocate the shared antenna to the WLAN RAT based at least in part on an operating condition of the WLAN RAT and/or the cellular RAT, as shown in block 604.

FIG. 7 is a flow chart depicting another exemplary operation of a wireless device dynamically sharing antennas in accordance with some aspects. As shown in FIG. 7, a device in a wireless system, that may be at least a UE, eNodeB, or an access point, may configure a shared antenna for use by a wireless local area network (WLAN) radio access technology (RAT) or a cellular RAT as shown in block 702, and may compare a strength of the shared antenna to a dedicated WLAN antenna of a UE having a single receive chain, as shown in block 704. Further, the device in the wireless system may allocate the shared antenna or the dedicated WLAN antenna for WLAN communication based at least in part on the comparison, as shown in block 706.

FIG. 8 is a diagram illustrating an example of a hardware implementation for an apparatus 800 employing a dynamic antenna sharing system 814. The apparatus 800 may include a configuring module 802, an allocating module 804 and a comparing module 806. The dynamic antenna sharing system 814 may be implemented with a bus architecture, represented generally by the bus 824. The bus 824 may include any number of interconnecting buses and bridges depending on the specific application of the dynamic antenna sharing system 814 and the overall design constraints. The bus 824 links together various circuits including one or more processors and/or hardware modules, represented by the processor 826, the configuring module 802, the allocating module 804, the comparing module 806, and the computer-readable medium 828. The bus 824 may also link various other circuits such as timing sources, peripherals, voltage regulators, and power management circuits, which are well known in the art, and therefore, will not be described any further.

The apparatus includes a dynamic antenna sharing system 814 coupled to a transceiver 822. The transceiver 822 is coupled to one or more antennas 820. The transceiver 822 provides a means for communicating with various other apparatus over a transmission medium. The dynamic antenna sharing system 814 includes a processor 826 coupled to a computer-readable medium 828. The processor 826 is responsible for general processing, including the execution of software stored on the computer-readable medium 828. The software, when executed by the processor 826, causes the dynamic antenna sharing system 814 to perform the various functions described above for any particular apparatus. The computer-readable medium 828 may also be used for storing data that is manipulated by the processor 826 when executing software. The dynamic antenna sharing system 814 further includes the configuring module 802 for configuring a shared antenna for use by a WLAN RAT or a cellular RAT. The dynamic antenna sharing system 814 further includes the allocating module 804 for allocating the shared antenna to the WLAN RAT based at least in part on an operating condition of the WLAN RAT and/or the cellular RAT. The dynamic antenna sharing system 814 further includes the comparing module 806 for comparing a strength of the shared antenna to a dedicated WLAN antenna of a UE having a single receive chain. Further, the allocating module 804 may be configured to allocate the shared antenna or the dedicated WLAN antenna for WLAN communication based at least in part on the comparison. The modules may be software modules running in the processor 826, resident/stored in the computer readable medium 828, one or more hardware modules coupled to the processor 826, or some combination thereof. The dynamic antenna sharing system 814 may be a component of the UE 250 and may include the memory 272 and/or and the controller/processor 270.

In one configuration, the apparatus 800 for wireless communication includes means for configuring, means for comparing and means for allocating. The aforementioned means may be one or more of the aforementioned elements of the wireless device 300/500 and/or the dynamic antenna sharing system 814 of the apparatus 800 configured to perform the functions recited by the aforementioned means. As described above, the dynamic antenna sharing system 814 may include the configuring module 802, allocating module 804, comparing module 806, memory 272, and/or the controller/processor 270. As such, in one configuration, the aforementioned means may be the configuring module 802, allocating module 804, comparing module 806, memory 272, and/or the controller/processor 270 configured to perform the functions recited by the aforementioned means.

Note that, while the aspects above have been described specifically with respect to the transmission of Wi-Fi, Bluetooth, and LTE signals, the method described in FIG. 6 applies similarly for the reception of Wi-Fi, Bluetooth, and/or LTE signals. Furthermore, the LTE control circuit 423 may alternatively transmit and receive data in accordance with other cellular data protocols (e.g., EDGE, UMTS, WiMax, etc.).

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
configuring a shared antenna for use by a wireless local area network (WLAN) radio access technology (RAT) or a cellular RAT; and
allocating the shared antenna to the WLAN RAT when the cellular RAT is active based at least in part on an operating condition of the WLAN RAT and/or the cellular RAT.

2. The method of claim 1, further comprising allocating the shared antenna for WLAN communication when a signal to noise ratio (SINR) of the cellular RAT is above a SINR threshold and when a data rate of WLAN communication is below a data rate threshold.

3. The method of claim 1, further comprising adjusting a data rate of the WLAN communication based at least in part on an indication from a UE identifying a change in an antenna capability of the UE.

4. The method of claim 3, in which the indication is based on at least one of channel state information or management frame information from the UE.

5. A method of wireless communication, comprising:
configuring a shared antenna for use by a wireless local area network (WLAN) radio access technology (RAT) or a cellular RAT;
comparing a strength of the shared antenna to a dedicated WLAN antenna of a UE having a single receive chain; and
allocating the shared antenna or the dedicated WLAN antenna for WLAN communication based at least in part on the comparison.

6. The method of claim 5, further comprising adjusting a data rate of the WLAN communication based at least in part on an indication from a UE identifying a change in an antenna capability of the UE.

7. The method of claim 6, in which the indication is based on at least one of channel state information or management frame information from the UE.

8. An apparatus for wireless communication, comprising:
means for configuring a shared antenna for use by a wireless local area network (WLAN) radio access technology (RAT) or a cellular RAT; and
means for allocating the shared antenna to the WLAN RAT when the cellular RAT is active based at least in part on an operating condition of the WLAN RAT and/or the cellular RAT.

9. The apparatus of claim 8, in which the allocating means further comprises means for allocating the shared antenna for WLAN communication when a signal to noise ratio (SINR) of the cellular RAT is above a SINR threshold and when a data rate of WLAN communication is below a data rate threshold.

10. The apparatus of claim 8, further comprising means for adjusting a data rate of the WLAN communication based at least in part on an indication from a UE identifying a change in an antenna capability of the UE.

11. The apparatus of claim 10, in which the indication is based on at least one of channel state information or management frame information from the UE.

12. An apparatus for wireless communication, comprising:
means for configuring a shared antenna for use by a wireless local area network (WLAN) radio access technology (RAT) or a cellular RAT;
means for comparing a strength of the shared antenna to a dedicated WLAN antenna of a UE having a single receive chain; and
means for allocating the shared antenna or the dedicated WLAN antenna for WLAN communication based at least in part on a comparison by the comparing means.

13. The apparatus of claim 12, further comprising means for adjusting a data rate of the WLAN communication based at least in part on an indication from a UE identifying a change in an antenna capability of the UE.

14. The apparatus of claim 13, in which the indication is based on a channel state information and/or management frame information from the UE.

15. An apparatus for wireless communication, comprising:
a memory; and
at least one processor coupled to the memory and configured:
to configure a shared antenna for use by a wireless local area network (WLAN) radio access technology (RAT) or a cellular RAT; and
to allocate the shared antenna to the WLAN RAT when the cellular RAT is active based at least in part on an operating condition of the WLAN RAT and/or the cellular RAT.

16. The apparatus of claim 15, in which the at least one processor is further configured to allocate the shared antenna for WLAN communication when a signal to noise ratio (SINR) of the cellular RAT is above a SINR threshold and when a data rate of WLAN communication is below a data rate threshold.

17. The apparatus of claim 15, in which the at least one processor is further configured to adjust a data rate of the WLAN communication based at least in part on an indication from a UE identifying a change in an antenna capability of the UE.

18. The apparatus of claim 17, in which the indication is based on at least one of channel state information or management frame information from the UE.

19. An apparatus for wireless communication, comprising:
a memory; and
at least one processor coupled to the memory and configured:
to configure a shared antenna for use by a wireless local area network (WLAN) radio access technology (RAT) or a cellular RAT;
to compare a strength of the shared antenna to a dedicated WLAN antenna of a UE having a single receive chain; and
to allocate the shared antenna or the dedicated WLAN antenna for WLAN communication based at least in part on a comparison by the processor.

20. The apparatus of claim 19, in which the at least one processor is further configured to adjust a data rate of the WLAN communication based at least in part on an indication from a UE identifying a change in an antenna capability of the UE.

21. The apparatus of claim 20, in which the indication is based on a channel state information and/or management frame information from the UE.

22. A computer program product for wireless communications in a wireless network, comprising:
a computer-readable medium having non-transitory program code recorded thereon, the program code comprising:
program code to configure a shared antenna for use by a wireless local area network (WLAN) radio access technology (RAT) or a cellular RAT; and
program code to allocate the shared antenna to the WLAN RAT when the cellular RAT is active based at least in part on an operating condition of the WLAN RAT and/or the cellular RAT.

23. The computer program product of claim 22, in which the program code further comprises code to allocate the shared antenna for WLAN communication when a signal to noise ratio (SINR) of the cellular RAT is above a SINR threshold and when a data rate of the WLAN communication is below a data rate threshold.

24. The computer program product of claim 22, in which the program code further comprises code to adjust a data rate of the WLAN communication based at least in part on an indication from a UE identifying a change in an antenna capability of the UE.

25. The computer program product of claim 24, in which the indication is based on at least one of channel state information or management frame information from the UE.

26. A computer program product for wireless communications in a wireless network, comprising:
a computer-readable medium having non-transitory program code recorded thereon, the program code comprising:
program code to configure a shared antenna for use by a wireless local area network (WLAN) radio access technology (RAT) or a cellular RAT;
program code to compare a strength of the shared antenna to a dedicated WLAN antenna of a UE having a single receive chain; and
program code to allocate the shared antenna or the dedicated WLAN antenna for WLAN communication based at least in part on the comparison.

27. The computer program product of claim 26, in which the program code further comprises code to adjust a data rate of the WLAN communication based at least in part on an indication from a UE identifying a change in an antenna capability of the UE.

28. The computer program product of claim 27, in which the indication is based on a channel state information and/or management frame information from the UE.
